(19) United States
(12) Patent Application Publication
(10) Pub. No.: US 2007/0165933 A1
(43) Pub. Date: Jul. 19, 2007

(54) Method for pre-fetching digital image data

(75) Inventors: Lance P. Thomas, East Hawthorn (AU); Robert Hofstetter, Carlton (AU)

Correspondence Address: BIRCH STEWART KOLASCH & BIRCH, PO BOX 747, FALLS CHURCH, VA, 22040-0747, US

(73) Assignee: Intellirad Solutions Pty Ltd

(21) Appl. No.: 11/642,632

(22) Filed: Dec. 21, 2006

(30) Foreign Application Priority Data
Dec. 22, 2005 (AU) 2005907248

(51) Int. Cl. G06K 9/00

(52) U.S. Cl. 382/128

(57) ABSTRACT

A method is disclosed for pre-fetching one or more images associated with a patient study for review by an operator of a diagnostic work station. The method includes the steps of the operator selecting a work list, the work list including a plurality of patient studies pending review by the operator. The method includes establishing a communication link between the diagnostic work station and an image archive, and downloading the one or more images associated with each patient study on the work list from the image archive to the diagnostic work station. The method further includes displaying the one or more images associated with each patient study to the operator on demand, wherein the images associated with the pending patient studies in the selected work list are automatically downloaded in anticipation that the images will be required for review by the operator.

### FIELD OF THE INVENTION

The present invention relates generally to methods for downloading image data stored in image archives such as a Picture Archive and Communication System (PACS) to a diagnostic work station. More particularly, the invention relates to downloading of digital medical images including radiographs and the like for review and reporting by medical professionals such as radiologists.

### BACKGROUND OF THE INVENTION

Digital medical images and patient studies stored in a Picture Archive and Communication System (PACS) are accessed by consulting radiologists on diagnostic workstations via a Local Area Network (LAN), Wide Area Network (WAN) and Internet for reviewing and reporting. The images and studies must be retrieved from the PACS server or other digital image archive to enable display of the images on each diagnostic workstation. Images that are accessed on remote workstations are typically displayed through a web type browser which provides only limited viewing, control and workflow capabilities.

Current digital medical imaging products retrieve images from image archives in one of two ways. Firstly, images may be retrieved through a local area network using a high bandwidth connection. In this case the images are pulled directly from the image archive. Some older image archiving systems are based on mechanical jukeboxes which handle tapes or optical disks. These systems are complex, slow and unreliable. Such systems use “pre-fetch” wherein the system must request retrieval of an image from a stored location ahead of time.

Where only a low bandwidth connection is available, systems use teleradiology. Teleradiology involves the transmission of digital images from one location to another over standard telephone lines, local area networks or wide area networks. Images may be sent from one PACS to another, or from PACS to a diagnostic workstation for review and reporting. Since image transmission time is directly proportional to the size of the digital image file, the larger the image file, the longer is the time required to transmit the image data from one location to another. Another drawback of the use of teleradiology is the possibility of double reporting of images, or failure to report images due to the lack of linkage between databases.

Consulting radiologists may move from workstation to workstation within and external to the image archive, PACS or PACS network, resulting in variations in bandwidths and connections to the hospital or radiology center. These variations in bandwidths and connections affect efficiencies in reporting, and the ability to share workload between radiologists. Accordingly, it would be desirable to improve the efficiency of radiologists, reduce the costs associated with accessing, reporting and distributing digital medical images, and improve patient diagnosis and outcomes.

### SUMMARY OF THE INVENTION

According to an aspect of the present invention, there is provided a method of pre-fetching one or more images associated with a patent study for review by an operator of a diagnostic work station, the method including the following steps:
(a) the operator selecting a work list, the work list including a plurality of patient studies pending review by the operator;
(b) establishing a communication link between the diagnostic work station and an image archive;
(c) downloading the one or more images associated with each patient study on the work list from the image archive to the diagnostic work station; and
(d) displaying the one or more images associated with each patient study to the operator on demand;

wherein the images associated with the pending patient studies in the selected work list are automatically downloaded in anticipation that the images will be required for review by the operator.

In a preferred embodiment of the invention, the method may further include the steps of:
(a) prioritizing the patient studies in the work list; and
(b) downloading the images associated with each patient study starting with the highest priority patient study and finishing with the lowest priority patient study.

The communication link may be a low or medium bandwidth network link but is preferably a low bandwidth network connection. Preferably, the communication link between the diagnostic work station and the image archive is continuously maintained.

In one embodiment, communication links may be established between the more than one diagnostic work station and the image archive. In an alternative embodiment, communication links may be established between the diagnostic work station and more than one image archive. In yet another embodiment, communication links may be established between more than one diagnostic work station and more than one image archive.

In one form of the invention, each patient study may be locked after reporting has been commenced by the operator relating to that patient study. A mechanism may enable the operator to lock one or more patient studies for future reporting. The locking mechanism may allow other operators to be notified when attempting to report these studies. In yet another form of the invention, locking one or more patient studies may initiate download of these studies/images to local storage of the work station.

The method may be preceded by the step of generating a single work list including a plurality of patient studies, wherein the images associated with the patient studies are archived in more than one image archive. Alternatively, the method may be preceded by the step of generating more than one work list, wherein the images associated with the patient studies on each work list are archived in a single image archive.

In another form of the invention, a patient study may be locked before downloading of the study images to the local workstation. The study then may not be downloaded to and reported by other reporting workstations. This may prevent excessive use of data bandwidth. The locking may be initiated automatically or manually for a specifically selected study or studies.

According to another aspect of the present invention, there is provided a method of more than one operator each operating a diagnostic work station to report a plurality patient studies, each patient study associated with one or more images stored in an image archive, the method including the following steps:
(a) each diagnostic work station operator selecting a work list, the work list including a plurality of patient studies pending review by the operator;
(b) establishing a communication link between the diagnostic work station and the image archive storing the one or more images;
(c) downloading the one or more images associated with each patient study on the selected work list from the image archive to the diagnostic work station;
(d) displaying the one or more images associated with each patient study to the operator;
(e) the operator reviewing the images and generating a report on each patient study on the selected work list; and
(f) locking each patient study once this patient study has been selected for a related report to be generated by an operator to prevent the operators of other diagnostic work stations connected to the same image archive from generating reports relating to the same patient study.

According to yet another aspect of the present invention, there is provided a method of reporting a plurality of patient studies, each patient study associated with one or more images, each image being stored in one of a plurality of image archives, the method including the following steps:
(a) generating a work list, the work list including a plurality of patient studies pending review by the operator of a diagnostic work station;
(b) establishing communication links between the diagnostic work station and each of the plurality of image archives;
(c) downloading the one or more images associated with each patient study on the work list from each of the plurality of image archives to the diagnostic work station; and
(d) displaying the one or more images associated with each patient study to the operator.

According to a further aspect of the present invention, there is provided a method of reporting a plurality of patient studies, each patient study associated with one or more images, each image being stored in one of a plurality of image archives, the method including the following steps:
(a) generating a plurality of work lists, each work list including a plurality of patient studies associated with images stored in one of the plurality of image archives;
(b) an operator of the diagnostic workstation selecting one of the plurality of work lists including a plurality-of patient studies pending review by the operator;
(c) establishing a communication link between the diagnostic work station and the image archive storing the images associated with the patient studies on the selected work list;
(d) downloading the one or more images associated with each patient study on the work list to the diagnostic work station; and
(e) displaying the one or more images associated with each patient study to the operator.

### BRIEF DESCRIPTION OF THE DRAWINGS

The invention will now be described in further detail by reference to the attached drawings illustrating example forms of the invention. It is to be understood that the particularity of the drawings does not supersede the generality of the preceding description of the invention. In the drawings:

FIG. 1 shows the flow of data involved in the preemptive download of image data according to an embodiment of the present invention.

FIG. 2 shows a typical workflow involving pre-emptive download of image data according to an embodiment of the present invention.

### DETAILED DESCRIPTION

The present invention relates to a method providing for timely presentation of diagnostic medical images on a diagnostic work station that is connected to a digital image archive, such as a Picture Archive and Communication System (PACS), or a PACS network. The communication link between the diagnostic work station and the image archive may be a low bandwidth network link, or a medium bandwidth network link.

The method provides for automatic pre-emptive downloading of medical images associated with a work list, saving time and increasing the efficiency of the operator of the diagnostic work station. The pre-emptive download is driven by the work list which is selected by, or allocated to, the operator of the diagnostic work station. The work list displays the operator's current list of patient studies that are awaiting interpretation and diagnosis. By opening the work list, the operator initiates the pre-emptive download of the images associated with the patient studies pending review.

The images associated with the patient studies pending review are downloaded from the image archive to the diagnostic work station in anticipation that they will be required for review by the operator of the diagnostic work station. This feature enables the images to be rapidly displayed on the monitor on demand.

The patient studies in the work list may be prioritized by the operator such that the images will be downloaded starting with the highest priority patient study and finishing with the lowest priority patient study. This provides the operator of the diagnostic work station with greater control over his or her work flow by controlling the order of download via the user interface.

Moreover, communication links may be simultaneously established between the diagnostic work station and multiple image archives, PACS or PACS networks. This enables medical images to be preemptively downloaded regardless of where they are archived.

The pre-emptive download allows the operator of a remote diagnostic work station to download the medical images associated with patient studies on their selected work list in the background. The studies in the work list are downloaded automatically onto the local work station, and will appear as a visible icon on the monitor once the download is complete. The icon will provide a link to the full patient study complete with images on the diagnostic work station. This enables the opening of the patient studies and associated images for review to be immediate, as if they were archived in a local PACS. Accordingly, remote diagnostic work stations can be integrated into the PACS network, just as if their operators were reviewing and reporting the patient studies locally.

Multiple remote diagnostic work stations may be connected to each image archive or PACS to allow concurrent reporting with other diagnostic work stations connected to the same image archives or PACS, whether the other diagnostic work stations are locally or remotely connected to the network. After the operator has commenced generating a report relating to a particular patient study, the patient study is locked. This avoids duplication in effort wherein more than one report is generated by diagnostic work station operators at remote locations for the same patient study. Whilst multiple diagnostic work stations may be enabled to access the images, only one is able to report the patient study to avoid double reporting of patient studies.

A mechanism may be provided whereby the operator can lock one or more patient studies for future reporting. The locking mechanism may notify other operators that the patient study has been locked if they attempt to report a locked patient study. The locking of a patient study may be set up to initiate download of the patient study and associated images to local storage of the work station.

Communication links may be established between a diagnostic work station and multiple independent image archives, networks or databases. This permits images to be downloaded from various remotely located archives. A single work list may be generated for all image archives with which links have been established, or a separate work list for each image archive. The diagnostic work station maintains a connection to the image archives whenever a network link is available.

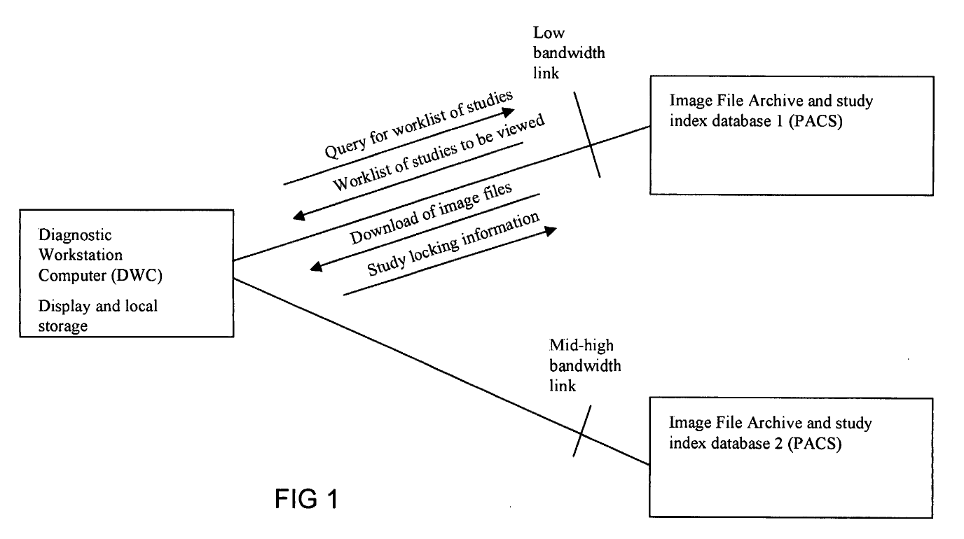

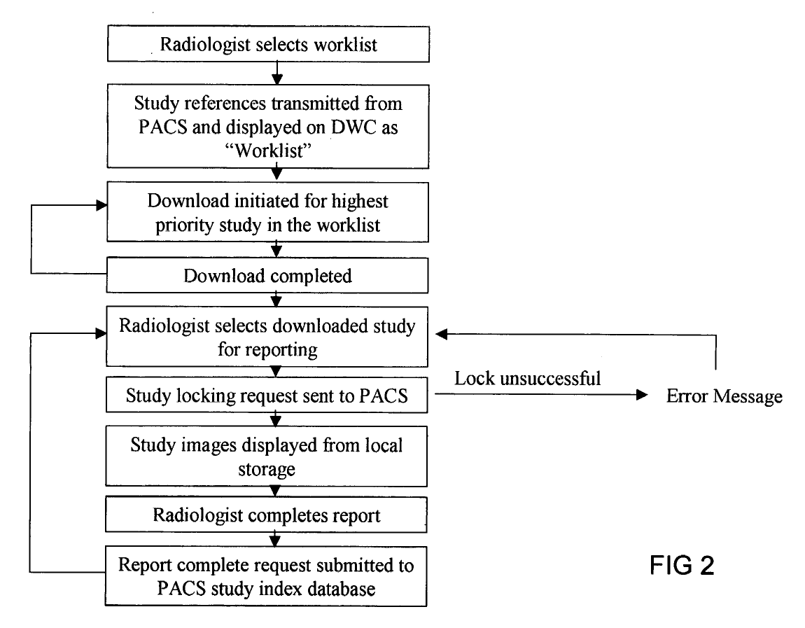

Referring now to FIGS. 1 and 2, there the diagnostic work station computer (DWC) is has established connections with two independent image archives and patient study index databases (PACS 1 and PACS 2). The communication link to PACS 1 is established via a low bandwidth network connection, whilst the communication link with PACS 2 is established via a medium bandwidth network connection.

The operator of the diagnostic work station submits a query for a work list of patient studies pending review. The work list is downloaded from PACS 1 for display on the diagnostic work station computer monitor. Downloading the work list to the work station automatically initiates download of the image files which are associated with the patient studies on the work list in question. The image files are therefore available on the diagnostic work station computer for review by the operator on demand.

Once the operator has reviewed and reported a particular patient study on the work list, that patient study is locked so that it cannot be reported again by some other diagnostic work station operator who has the same patient study on their work list.

For instance, the operator of a diagnostic work station may be logged onto two PACS networks simultaneously, e.g. the Toowoomba PACS network and the Cairns PACS network. The PACS to which the operator is connected is clearly indicated on the diagnostic work station monitor. This enables the consulting radiologist to work through his or her own work list and then assist in reporting patient studies for another site. The operator can toggle between the two sites at will.

It is to be understood that various additions, alterations and/or modifications may be made to the parts previously described without departing from the ambit of the invention.

1. A method of pre-fetching one or more images associated with a patient study for review by an operator of a diagnostic work station, the method including the following steps:
(a) the operator selecting a work list, the work list including a plurality of patient studies pending review by the operator;
(b) establishing a communication link between the diagnostic work station and an image archive;
(c) downloading the one or more images associated with each patient study on the work list from the image archive to the diagnostic work station; and
(d) displaying the one or more images associated with each patient study to the operator on demand;
wherein the images associated with the pending patient studies in the selected work list are automatically downloaded in anticipation that the images will be required for review by the operator.

2. A method according to claim 1, further including the steps of:
(a) prioritizing the patient studies in the work list; and
(b) downloading the images associated with each patient study starting with the highest priority patient study and finishing with the lowest priority patient study.

3. A method according to claim 1, wherein the communication link is a low bandwidth network connection.

4. A method according to claim 1, wherein the communication link between the diagnostic work station and the image archive is continuously maintained.

5. A method according to claim 1, wherein communication links are established between more than one diagnostic work station and the image archive.

6. A method according to claim 1, wherein communication links are established between the diagnostic work station and more than one image archive.

7. A method according to claim 1, wherein communication links are established between more than one diagnostic work station and more than one image archive.

8. A method according to claim 1, wherein each patent study is locked after reporting has been commenced by the operator relating to that patient study.

9. A method according to claim 6, preceded by the step of generating a single work list including a plurality of patient studies, wherein the images associated with the patient studies are archived in more than one image archive.

10. A method according to claim 6, preceded by the step of generating more than one work list, wherein the images associated with the patient studies on each work list are archived in a single image archive.

11. A method of more than one operator each operating a diagnostic work station to report a plurality patient studies, each patient study associated with one or more images stored in an image archive, the method including the following steps:
(a) each diagnostic work station operator selecting a work list, the work list including a plurality of patient studies pending review by the operator;
(b) establishing a communication link between the diagnostic work station and the image archive storing the one or more images;
(c) downloading the one or more images associated with each patient study on the selected work list from the image archive to the diagnostic work station;
(d) displaying the one or more images associated with each patient study to the operator;
(e) the operator reviewing the images and generating a report on each patient study on the selected work list; and
(f) locking each patient study once this patient study has been selected for a related report to be generated by an operator to prevent the operators of other diagnostic work stations connected to the same image archive from generating reports relating to the same patient study.

12. A method of reporting a plurality of patient studies, each patient study associated with one or more images, each image being stored in one of a plurality of image archives, the method including the following steps:
(a) generating a work list, the work list including a plurality of patient studies pending review by the operator of a diagnostic work station;
(b) establishing communication links between the diagnostic work station and each of the plurality of image archives;
(c) downloading the one or more images associated with each patient study on the work list from each of the plurality of image archives to the diagnostic work station; and
(d) displaying the one or more images associated with each patient study to the operator.

13. A method of reporting a plurality of patient studies, each patient study associated with one or more images, each image being stored in one of a plurality of image archives, the method including the following steps:
(a) generating a plurality of work lists, each work list including a plurality of patient studies associated with images stored in one of the plurality of image archives;
(b) an operator of the diagnostic workstation selecting one of the plurality of work lists including a plurality of patient studies pending review by the operator;
(c) establishing a communication link between the diagnostic work station and the image archive storing the images associated with the patient studies on the selected work list;
(d) downloading the one or more images associated with each patient study on the work list to the diagnostic work station; and
(e) displaying the one or more images associated with each patient study to the operator.
